(19) United States
(12) Patent Application Publication
(10) Pub. No.: US 2022/0388247 A1
(43) Pub. Date: Dec. 8, 2022

(54) ARRANGEMENT OF 3D PRINTING DEVICE

(71) Applicant: Voxeljet AG, Friedberg (DE)

(72) Inventors: Bastian HEYMEL, Augsburg (DE); Tobias LACHENMAIR, Augsburg (DE); Ingo EDERER, Augsburg (DE); Josef GRASEGGER, Stadtbergen (DE); Martin SINZINGER, Augsburg (DE)

(21) Appl. No.: 17/618,297

(22) PCT Filed: Jun. 23, 2020
(86) PCT No.: PCT/DE2020/000140

§ 371 Date: Dec. 10, 2021

(30) Foreign Application Priority Data
Jun. 23, 2019 (DE) 10 2019 004 342.1

(51) Int. Cl. B29C 64/393; B33Y 30/00; B33Y 50/02; B29C 64/321; B33Y 40/00; B28B 1/00; B28B 17/00; B22F 10/85; B22F 12/50

(52) U.S. Cl. CPC B29C 64/393; B33Y 30/00; B33Y 50/02; B29C 64/321; B33Y 40/00; B28B 1/001; B28B 17/0081; B22F 10/85; B22F 12/50

(57) ABSTRACT

The invention relates to an arrangement for the layer-by-layer formation of mouldings from a particulate material, comprising at least one process unit which can be guided to and installed in the arrangement, preferably automatically, and which comprises a printing unit and a coating system with a dynamic filling system; or/and a receiving device for a building container; a preferably automatic feeder for the building container; and an adjustment device for offline preparation of the process unit.

### CLAIM OF PRIORITY

This application is a national phase filing under 35 USC § 371 from PCT Patent Application serial number PCT/DE2020/000140 filed on Jun. 23, 2020 and claims priority therefrom. This application further claims priority to German Patent Application number DE 10 2019 004 342.1 filed on Jun. 23, 2019. PCT/DE2020/000140 and DE 10 2019 004 342.1 are each incorporated herein by reference in its entirety.

### FIELD

The invention relates to a device and to a method for producing 3D moldings using at least one process unit, which is also suitable, in particular, for large scale series production of 3D moldings such as foundry cores and molds and other articles which are required in large quantities.

### BACKGROUND

European Patent EP 0 431 924 B1 describes a process for producing three-dimensional objects based on computer data. In the process, a thin layer of particulate material is deposited on a platform by means of a recoater and has a binder material selectively printed thereon by means of a print head. The particulate region with the binder printed thereon bonds and solidifies under the influence of the binder and, optionally, an additional hardener. Next, the construction platform is lowered by one layer thickness or the recoater/print head unit is raised and a new layer of particulate material is applied, the latter also being printed on selectively as described above. These steps are repeated until the desired height of the object is achieved. Thus, the printed and solidified regions form a three-dimensional object (molding).

Upon completion, the object made of solidified particulate material is embedded in loose particulate material, from which it is subsequently freed. For this purpose a suction device may be used, for example. This leaves the desired objects which are then further cleaned of any residual powder, e.g. by brushing it off.

Other powder-based rapid prototyping processes, e.g. selective laser sintering or electron beam sintering, work in a similar manner, also applying loose particulate material layer by layer and selectively solidifying it using a controlled physical source of radiation.

In the following, all these processes will be summarized by the term “three-dimensional printing method” or “3D printing method”.

Some of these methods use different coating options. In some methods, the particulate material required for the entire layer is placed in front of a thin blade. The latter is then moved over the construction area, spreading the material placed in front of it and thereby smoothing it. Another type of layer application consists in continuously placing a small volume of particulate material in front of the blade as it moves. For this purpose, the blade is usually mounted to the underside of a movable silo. Directly above or next to the blade, an adjustable gap is provided through which the particulate material can flow out of the silo. The flow is stimulated by introducing oscillations into the silo/blade system.

Subsequently or during layer application, selective solidification follows by means of liquid application and/or exposure to radiation. In many cases it is necessary for the quality of the print that the distance of the moving printing device to the current layer plane be as constant as possible.

The parts are usually present in a construction container after printing. In most cases, said construction container constitutes a cuboid volume. The volume is charged with a wide variety of geometries so as to make efficient use of the machine.

Some prior art printers have construction containers which can be removed from the machine and are also referred to as job boxes or construction containers. They serve as boundaries for the powder, thereby stabilizing the construction process. Changing the construction container allows the process steps to be carried out in parallel, thus making efficient use of the machine. There are also machines which involve printing on a platform which can be removed from the machine, just like the construction container. Methods are also known which involve printing on a continuous conveyor belt at a certain angle. The aforementioned machine features allowed to make construction processes more economical and help reduce downtime. However, well-known 3D printers still have the disadvantage that considerable downtimes of the machines mean a suboptimal degree of utilization.

3D printing on the basis of pulverulent materials and introduction of liquid binders is the quickest method among the layer construction techniques. This method allows the processing of different particulate materials, including—as a non-exhaustive example—natural biological raw materials, polymeric plastic materials, metals, ceramics and sands.

The construction field plane, on the other hand, is determined by the coating blade in contact with the powder and by the coating blade's traversing axis.

Now, if one or more of the components (coating blade, print head or radiation source) is replaced, the spare parts and their receptacles must either be manufactured so precisely that the required parallel alignment is restored, or there must be devices on one of the two elements that allow them to be adjusted to each other.

Usually the manufacturing accuracy of the machine parts or spare parts is not sufficient to meet the accuracy requirements mentioned. For this reason, replacing one of the components requires the machine to be switched off for the duration of the replacement and readjustment. Depending on the type of machine, this can require several hours of machine downtime. In addition, the work must be performed directly on the machine by an experienced technician.

The aforementioned downtimes of the 3D printing machines imply significant economic disadvantages and especially for 3D printing machines or production lines that are designed to achieve a high production throughput, the aforementioned downtimes are problematic or even incompatible with the required production targets.

Also, in many cases 3D printing machines cannot be integrated into series production because they require excessively long downtimes for maintenance work and thus contribute to slowing down the other production steps.

It is therefore an object underlying the invention to provide a device with which a maximum output of printed parts is achieved with a high degree of automation while minimizing downtimes.

A further object underlying the application is to provide a device which enables a high degree of automation and preferably in-line quality control.

### SUMMARY

The disclosure relates to an arrangement for layer-by-layer formation of moldings from a particulate material, comprising

at least one process unit which can be guided to and installed in the arrangement, preferably automatically, and which comprises a printing unit and a recoater with a dynamic filling system; or/and an automatic feeder for a construction container; and an adjustment device for offline preparation of the process unit.

In one aspect, the disclosure relates to an arrangement for layer-by-layer formation of moldings from a particulate material, and which comprises at least one process unit which can be guided to and installed in the arrangement, said process unit comprising a printing unit and a coating system, and an adjustment device for offline preparation of the process unit.

In one aspect, the disclosure relates to an arrangement for layer-by-layer formation of moldings from a particulate material, and which comprises at least one process unit which can be guided to and installed in the arrangement, said process unit comprising a printing unit and a coating system, and a digital camera, a line camera or an IR camera, movable together with the process unit, for measurement of the construction field temperature or/and of the print image.

Preferably, the arrangement according to the present invention comprises a heat sensor, for example an IR camera, for measuring a construction field temperature, and optionally an air conditioner. According to a preferred embodiment, said heat sensor can preferably be connected to the air conditioner via a control and process unit.

According to a particularly preferred embodiment, a line sensor is provided in the area between the recoater unit and the printing unit.

Preferably, said line sensor is connected to another process and control unit in order to enable a direct correction of the process factors, preferably in closed-loop mode, depending on the measurement by the line sensor.

### BRIEF DESCRIPTION OF THE DRAWINGS

FIG. 1 shows a schematic front view of an arrangement according to a preferred embodiment of the invention;

FIG. 2 shows a cross-section of a process unit according to a further preferred embodiment of the invention;

FIG. 3 shows a top view of the process unit according to FIG. 2;

FIG. 4 shows a front view of an adjustment device according to a further preferred embodiment of the invention;

FIG. 5 shows a front view of a transport box according to a further preferred embodiment of the invention;

FIG. 6 shows a representation of a removal aid according to a preferred embodiment;

FIG. 7 shows a recoater and a feed container according to a preferred embodiment of the present invention, and

FIG. 8 shows a top view (a) and front view (b) of the construction container feeder (job box feeder) according to a preferred embodiment.

### DETAILED DESCRIPTION

In the following, several terms will be defined more precisely. Otherwise, the terms used shall have the meanings known to the person skilled in the art.

In the sense of the disclosure, “layer construction methods” or “3D printing methods”, respectively, are all methods known from the prior art which enable the construction of parts in three-dimensional shapes and are compatible with the process components and devices further described herein.

As used in the disclosure, “binder jetting” means that powder is applied in layers onto a construction platform, one or more liquids is/are printed on the cross-sections of the part on this powder layer, the position of the construction platform is changed by one layer thickness with respect to the previous position, and these steps are repeated until the part is finished. In this context, binder jetting also refers to layer construction methods that require a further process component such as layer-by-layer exposure, e.g. with IR or UV radiation, and methods that are also referred to as high-speed sintering.

A “molded article” or “part” or “3D molding” or “3D part” in the sense of the disclosure means all three-dimensional objects manufactured by means of 3D printing methods and exhibiting dimensional stability.

“3D printer” or “printer” as used in the disclosure means the device in which a 3D printing method can take place. A 3D printer in the sense of the disclosure comprises a means for applying construction material, e.g. a fluid such as a particulate material, and a solidification unit, e.g. a print head or an energy input means such as a laser or a heat lamp. Other machine components known to the person skilled in the art and components known in 3D printing are combined with the above-mentioned machine components in individual cases, depending on the specific requirements.

A “construction field” is the plane or, in a broader sense, the geometric location on or in which a particulate material bed grows during the construction process by repeated coating with particulate material. The construction field is frequently bounded by a bottom, i.e. the “construction platform”, by walls and an open top surface, i.e. the construction plane.

As used in the disclosure, “process unit” or “function unit” refers to a means or a component using which the result of the processes of coating and selective solidification can be realized; this may include recoater, print head, nozzles, laser unit, heat source, UV light source or/and further layer treatment means.

The process of “printing” or “3D printing” in the sense of the disclosure summarizes the operations of material application, selective solidification or imprinting and working height adjustment and takes place in an open or closed process chamber.

A “receiving plane” in the sense of the disclosure means the plane onto which the construction material is applied. In accordance with the disclosure, the receiving plane is always freely accessible in one spatial direction by a linear movement.

A “traversing axis” in the sense of the disclosure is an axle which carries a process unit or which can be produced along the latter, is arranged above the construction field tools and has a long travel compared to the other axles in the system. “Traversing axis” may also indicate the direction in which, for example, a construction field tool is synchronized and can be moved in coordination with other device parts. A print head can also be moved on a “traversing axis”.

“Construction field tool” or “functional unit” in the sense of the disclosure refers to any means or device part used for fluid application, e.g. particulate material, and selective solidification in the production of moldings. Thus, all material application means and layer treatment means are also construction field tools or functional units.

According to the disclosure, “spreading out” means any manner in which the particulate material is distributed. For example, a larger quantity of powder may be placed at the starting position of a coating pass and may be distributed or spread out into the layer volume by a blade or a rotating roller.

As the “construction material” or “particulate material” or “powder” in the sense of the disclosure, all flowable materials known for 3D printing may be used, in particular in the form of a powder, slurry or liquid. These may include, for example, sands, ceramic powders, glass powders and other powders of inorganic or organic materials, such as metal powders, plastic materials, wood particles, fiber materials, celluloses or/and lactose powders, as well as other types of organic, pulverulent materials. The particulate material is preferably a free-flowing powder when dry, but a cohesive, cut-resistant powder may also be used. This cohesiveness may also result from adding a binder material or an auxiliary material, e.g. a liquid. The addition of a liquid can result in the particulate material being free flowing in the form of a slurry. Synthetic resins such as epoxides or acrylates can also be considered as construction materials in the sense of the disclosure. In general, particulate materials may also be referred to as fluids in the sense of the disclosure.

The “surplus quantity” or “overfeed” is the amount of particulate material which is pushed along in front of the recoater during the coating pass at the end of the construction field.

“Recoater” or “material application means” as used in the disclosure refers to the unit by means of which a fluid is applied onto the construction field. The unit may consist of a fluid reservoir and a fluid application unit. According to the present invention, the fluid application unit comprises a fluid outlet and a “coating knife device”. Said coating knife device may be a coating blade. However, any other conceivable, suitable coating knife device may be used. For example, rotating rollers or a nozzle are conceivable as well. Material can be fed via reservoirs in a free-flowing manner or via extruder screws, pressurization or other material conveying devices. A recoater with one material outlet opening or two material outlet openings in opposite directions may be used. Blades can be attached to the material outlet openings for applying the material. These can be controlled by generating oscillations, and so the outlet can be controlled by bridging or material cone formation in the powder material, or the bridging or material cone formation can be broken up and controlled by blowing in gas, e.g. circulating air. The recoater can be combined with print heads arranged laterally on it and thus coating can be carried out bidirectionally and also the binder application can then be carried out in both directions during the pass. This arrangement can also be combined with cameras, there preferably being arranged, on both sides, a digital camera, a line scan camera or an IR camera, for measuring the construction field temperature or/and the print image. The recoater may be part of a process unit.

The “print head” or means for selective solidification in the sense of the disclosure usually consists of various components. Among other things, these can be printing modules. The printing modules have a large number of nozzles from which the “binder” is ejected as droplets onto the construction field in a controlled manner. The printing modules are aligned with respect to the print head. The print head is aligned with respect to the machine. This allows the position of a nozzle to be assigned to the machine coordinate system. The plane in which the nozzles are located is usually referred to as the nozzle plate. Another means of selective solidification can also be one or more lasers or other radiation sources or a heat lamp. Arrays of such radiation sources, such as laser diode arrays, can also be considered. It is permissible in the sense of the disclosure to implement selectivity separately from the solidification reaction. Thus, a print head or one or more lasers can be used to selectively treat the layer and other layer treatment means can be used to start the solidification process. An example of this would be printing on the layer with UV reactive resins, which are then solidified via a UV light source. In another embodiment, an IR absorber is printed on the particulate material, followed by solidification using an infrared source. The print head may be part of a process unit.

“Layer treatment means” in the sense of the disclosure refers to any means suitable for achieving a certain effect in the layer. This may be the aforementioned units such as print heads or lasers, but also heat sources in the form of IR emitters or other radiation sources such as UV emitters, for example. Means for deionization or ionization of the layer are also conceivable. What all layer treatment means have in common is that their zone of action is distributed linearly over the layer and that, like the other layering units such as the print head or recoater, they must be guided over the construction field to reach the entire layer.

“Actuators” in the sense of the disclosure are all technical means which are suitable for triggering the movement of layer treatment means relative to one another within an exchangeable function unit, or for carrying out movements of individual parts or components within the layer treatment means.

“Insertion opening” as used in the disclosure means the area on a 3D printing machine where the exchangeable function unit is inserted into and removed from the 3D printing machine for replacement; said insertion opening may be open or may be closable by suitable means such as a closure or a closable flap. Opening and closing can be done with a separate control; or, by retracting and extending the exchangeable function unit, the closure is automatically opened and closed again. There may also be some kind of barrier at the insertion opening, such as a slitted film or bristles, through which the exchangeable function unit can be pushed.

A “suitable receiving means” in the sense of the disclosure is a means arranged at the target position that assists in the positioning and proper functioning of the exchangeable function unit at the target position. Thus, the positional tolerance of an exchangeable function unit within the 3D printing machine is defined by a suitable receiving means, and thus also the positional tolerance of the layer treatment means with respect to the construction field.

“Connecting means” in the sense of the disclosure may be rails, frames or other parts by which the functional units of the exchangeable function unit are connected to each other and arranged in their three dimensions, and which may optionally also serve to support the retraction and extension of the exchangeable function unit into and out of the 3D printing machine. In a specific embodiment, the functional units can also be directly connected to each other and, in addition, means intended for retracting and extending the exchangeable function unit can be attached to the latter. Preferably, the connecting means are designed in such a way that the individual functional units are easily accessible in order to adjust their position or exchange them.

“Closure means” within the meaning of the disclosure is any means used to close the insertion opening for the exchangeable function unit, e.g. a flap, door, slide, row of brushes, etc.

“Supply” in the sense of the disclosure is the supply of energy, construction material or other media such as, for example, compressed air or cooling water to the individual functional units. The supply is preferably configured for quick coupling by suitable measures. The coupling preferably takes place at a common coupling position in the form of a coupling strip or a coupling block. The supply can preferably be coupled without additional manual interaction, e.g. only by moving it in and out.

For the purposes of the disclosure, “preset” means that the functional units contained in the exchangeable function unit are aligned in terms of location and position such that simply moving them to the target position, using the securing means and establishing the media supply is sufficient to enable the 3D printing machine to be returned to operation immediately after such movement, without substantially requiring any adjustment or readjustment or any setting in relation to the exchangeable function unit.

“Target position” in the sense of the disclosure is the position in the 3D printing machine up to which the exchangeable function unit is inserted and at which it is preferably fixed with the securing means.

“Removal position” as used in the disclosure means the location in the 3D printing machine at which the function unit must be located in order to extend it from the machine. Accordingly, the control of the 3D printer has a command upon which the exchangeable function unit approaches the removal position with sufficient accuracy. Advantageously, this position is above the construction field. Even more advantageously, the removal position is approximately in the middle above the construction field. The two possible end positions of the exchangeable function unit are less suitable, as the maintenance units for the construction field tools are usually located there and these could be damaged during retraction or extension. When exchanging the function unit, the construction field tools should advantageously not be in engagement with a current layer. This can be ensured, for example, by lowering the construction platform by an appropriate amount beforehand. This process can also be stored in the control system so that the lowering of the construction platform and the movement to the removal position takes place as a combined sequence in preparation for the replacement of the function unit.

The term “process unit” as used in the disclosure refers to the combination of several layer application means, layer treatment means and a print head. Preferably, the process unit consists of a central print head, which is as wide as the construction field and which has a print head traversing axis, followed on both sides by two recoaters or layer application means with the associated hoppers for feeding the particulate material. Subsequently, further layer treatment means are mounted, e.g. in the form of IR radiators. In addition, other inspection means such as line scan cameras can be located on the process unit. The process unit has a self-supporting structure and can be separated from the machine by an appropriate coupling device.

“Coupling point” as used in the disclosure means the position of the process unit in the machine that is most suitable for removing the process unit from the machine. This can be a central position, for example, where the process unit can be removed sideways or upwards.

“Application unit” or “layer application unit” means a combination of recoater and hopper.

“Zero point clamps” in the sense of the disclosure refers to clamping means which serve repeatable exact positioning of the respective material to be clamped.

For quality assurance, it is interesting to optically record each processed layer, e.g. with a line scan camera, and possibly evaluate it via special software. For example, if there is a corresponding contrast between printed and unprinted particulate material, it is possible to determine whether the printing process was carried out correctly. In a 3D printer of the prior art, a digital camera with an appropriate lens is usually sufficient for this purpose. The camera is suspended in a corner of the construction space, for example, and aimed at the construction field. In the embodiment according to the invention, however, the process unit obscures each layer in such a way that no clear view of the printed particulate material is possible. Rather, after each pass of the process unit, there is a printed layer already covered with a new layer of particulate material.

In order to still obtain an evaluable image, a so-called line scan camera can be used. This is a digital camera whose pixels are only arranged in an elongated manner, namely distributed across the entire width of the construction field. A two-dimensional image is created only when the camera is moved over the image to be recorded and the recorded points are stored along with the respective position of the line scan camera. The advantage of this approach is that the camera only requires very little space and can be easily integrated into the process unit after the print head. Preferably, the process unit then has two line scan cameras mounted to the left and right of the print head to be able to record each layer. Without limiting the generality hereof, however, other camera systems can also be used that have, for example, suitable optics to record an image between the print head and recoater. In this case, too, the device preferably has at least two camera systems, each recording its images on the left and right of the print head, or one camera recording images on the left and right of the print head via corresponding optics. When using a normal camera, with a two-dimensional image field, a complete layer image is produced, just like when using a line scan camera, via composition of several individual images, which are recorded when the process unit moves over the construction field.

The term “offset axis” as used in the disclosure refers to the device for displacing the print head transversely to the direction of printing. To avoid overlapping of weak or malfunctioning nozzles on the print head, it is advantageous to shift the print head by a certain amount, preferably not the same amount, before each print run. This is done with the offset axis. For the print image to be of high quality, the offset axis must be sufficiently accurate and have good resolution. Usually, the resolution of the traversing movement should be at least half the print resolution. The positioning accuracy of the offset axis should be even higher. Combinations of linear guides and a ball screw with a servo motor are suitable for this task.

All application units including the print head require regular cleaning. Such cleaning can be done passively, e.g. via stationary brushes. However, the cleaning devices can also actively perform the cleaning process with their own movement means.

In one aspect, the disclosure relates to an arrangement for layer-by-layer formation of moldings from a particulate material, comprising

at least one process unit which can be guided to and installed in the arrangement, preferably automatically, and which comprises a printing unit and a recoater with a dynamic filling system;

an automatic feeder for a construction container; and

an adjustment device for offline preparation of the process unit.

In another aspect, the disclosure relates to an arrangement for layer-by-layer formation of moldings from a particulate material, comprising

at least one process unit which can be guided to and installed in the arrangement, said process unit comprising a printing unit and a coating system, and a digital camera, a line camera or an IR camera, movable together with the process unit, for measurement of the construction field temperature or/and of the print image.

The adjustment device for offline preparation of the process unit is also provided in particular to minimize the downtimes of the arrangement in production operation. It is therefore proposed to perform the adjustment of the process unit offline in a specially designed device. Such device can, for example, be provided with integrated measuring equipment, which allows the process unit to be set up, measured and, if necessary, readjusted in an installation situation simulating the machine. For this purpose, the adjustment device can, for example, be equipped with suitable guide elements, preferably having a flatness of +/−0.02 mm over the entire traversing range, preferably approx. 1 m×1.5 m, in order to move the measuring head in the X and Y directions along the process unit. Ideally, the measuring head is an electronic device so that the measurement data can be automatically entered into a log.

Preferably, the arrangement according to the present invention comprises a heat sensor, for example an IR camera, for measuring a construction field temperature, and optionally an air conditioner or a heat source, e.g. in the form of an IR radiator. According to a preferred embodiment, said heat sensor can preferably be connected to the air conditioner and/or to the heat source via a control and process unit.

Since thermal management generally makes a decisive contribution to the quality of parts in 3D printing processes, it is proposed in accordance with a preferred embodiment to equip the arrangement according to the invention with an IR sensor, e.g. an IR camera system, which enables continuous observation of the construction field temperature. If this sensor is then connected to the air conditioner via a process and control unit, in-line closed-loop thermal management could take place.

According to a particularly preferred embodiment, a line sensor is provided in the area between the recoater unit and the printing unit.

Preferably, said line sensor is connected to another process and control unit in order to enable a direct correction of the process factors, preferably in closed-loop mode, depending on the measurement by the line sensor.

A major disadvantage of the systems available on the market is that the print result is only visible at the end of the complete printing operation, i.e. when the job box is unpacked. Since this can sometimes take several hours, a lot of precious time is lost. Newer systems already use common camera systems to inspect the printed image after the respective layer has been completed.

This technique cannot be used, in particular, in a bidirectional mode of operation. It is therefore proposed to mount a sensor between the print head and the recoater so that in situ inspection of the print image is also possible in the bidirectional mode of operation. For this purpose, a line scan camera was integrated in each case between the print head, the right and left recoater and then equipped with specially adapted software, which can then compare the real print image with the target image and thus show the operator any faults in the process at an early stage. The operator can then decide whether to abort printing or let it continue to the end. Furthermore, if several parts are printed at the same time, the machine operator could also sort out individual parts that may show conspicuous images.

In accordance with the present invention, it is now possible, among other things, for downtimes to be reduced, since, for example, the use of a process unit for replacement also provides aids which enable the device to be replaced quickly and put back into operation at short notice.

With the device according to the invention, it is advantageously possible to reduce or avoid the downtimes of 3D printing machines caused by maintenance work or the necessary replacement of parts or functional components that are susceptible to wear. Thus, the machine running time can be increased and it becomes possible to integrate one or more 3D printing machines into a network of other production systems, e.g. in series production, for example in vehicle construction.

The invention thus makes it possible for the first time to integrate 3D printing machines into substantially fully automated production processes.

Previously, certain 3D printed parts had to be pre-produced and, in certain conditions, these parts could be a time-limiting factor in other production processes. In addition, storage and delivery involved organizational effort and costs.

The invention makes it possible to produce 3D moldings directly on site and integrated into other semi-automated or fully automated manufacturing processes. This makes it possible to simplify complex manufacturing processes.

The invention thus advantageously contributes to further automation of 3D printing processes per se as well as other manufacturing processes and types of series production using 3D printing processes.

Such a 3D printing machine has the advantages described above and likewise achieves the objects underlying the application.

Furthermore, a 3D printing device disclosed herein may comprise an insertion opening with a closure means, wherein the closure means can be opened and closed or the closure means is opened or penetrated by the process unit according to any one of claims 1 to 8 during retraction and extension.

In another aspect, the disclosure relates to a method for retracting or/and extending, i.e. changing or exchanging, an exchangeable process unit as described above into or out of a 3D printing device, wherein the process unit is optionally moved to the 3D printing device by a lifting means, optionally a crane, a lifting platform or a lifting trolley, the process unit is inserted into the insertion opening, is positioned at the target position in the 3D printing device and is secured by means of one or more securing means.

With such a method, it is possible for the first time to simply exchange several process units quickly and easily without the need for complicated adjustment work on the machine itself during the exchange and the associated disadvantages described. Advantageously, an exchangeable process unit is used which comprises several functional units that are pre-adjusted, so that complex and time-consuming adjustment work on the machine itself is not necessary.

Further aspects of the disclosure will be described below.

In well-known 3D printing machines, print heads and coating blades are essential wear parts. In addition, there are exposure units and/or irradiation units, depending on the process.

These units must be aligned with each other within a certain framework for a good print result. The recoater defines the spatial position of the layer plane and the print head should be guided at as constant a distance as possible from the layer plane.

If a single component is exchanged, it must be adjusted to the respective other components, depending on the individual configuration. Due to the size of the machines, the manufacturing accuracy of the parts in relation to each other is usually not sufficient to achieve the desired result without adjustment.

Adjustment in the machine can also be a complex task, as it takes place in a confined space and accessibility is not given. In addition, the machine may need to be put in a special safe set-up mode to allow an operator to handle the units. After all, there may be process media in the machine from which the set-up personnel must be protected.

The recoater is a unit for dispensing fluid media such as particulate materials, resins, slurries or pastes in a defined form onto a substrate so that a flat layer of this media of predetermined thickness is formed. A recoater can be used to apply pulverulent/particulate materials.

The recoater could, for example, be configured as a roller that rotates in the opposite direction to the coating direction. A particulate material reservoir could be added to the roller. The reservoir could, for example, dose particulate material in front of the roller in a controlled manner via a rotary feeder.

A further embodiment relates to an oscillating recoater with a powder reservoir suspended in an oscillating manner and a gap in the lower region, on a side of the powder reservoir which points in the coating direction, said gap being as wide as the construction field. The recoater also has a drive that makes the reservoir oscillate, causing the powder to trickle out of the gap.

In one aspect, inkjet-type devices can be used as print heads, but it is also conceivable to use selective exposure units such as lasers, projectors or mirrors via which selective irradiation units can be projected onto the construction field. Alternatively, other devices can be used for the transfer of information, such as toners or ink transfer rollers known from laser printers or offset printing, for example.

In addition, other units such as exposure units may be attached, which act similarly to the recoater over the entire width of the unit. These exposure units can emit energy to the construction field, e.g. in the UV range but also in the heat radiation range. It is also conceivable that drying units are attached, which work, for example, via the supply and removal of hot air.

In addition to these components in the exchangeable process unit, it is also conceivable, however, that the exchangeable process unit consists of combinations of several recoaters, one or more print heads and several irradiation units.

In the machine itself, traversing axles are mounted in such a way that they can easily pick up the exchangeable process unit and move it across the construction field. Preferably, only one pair of axles is required for this, which is located parallel to the coating direction, laterally with respect to the construction field.

In one embodiment, the exchangeable process unit is moved from one reversal position to the other and produces a fully processed layer during this movement.

The machine may also have maintenance units that affect parts of the exchangeable process unit and that also need to be approached from time to time. This can be, for example, a print head cleaning station and/or a recoater cleaning station. In alternative embodiments, such maintenance units could also be mounted on the exchangeable process unit and exchanged with it.

The machine also has units for supplying the exchangeable process unit with media, such as particulate materials, inks and energy.

The machine has a rectangular construction field. Rectangular construction fields have been found to be advantageous over square, or otherwise shaped construction fields in accordance with the present disclosure and, in the context of the present disclosure, in the binder jetting 3D printing process and device arrangement employed herein. In this way, the output of the application means can be advantageously optimized.

In one aspect, the construction field has a short side and a long side. The application means are moved over the construction field via the short side. For example, the short side length is between 0.3 and 2.5 m, e.g. between 0.5 and 1.5 m. For example, the long side measures between 1.2 and 4 times the length of the short side, even more advantageously between 1.2 and 2.5 times the length of the short side.

Along the two short sides, there are means to guide the application units across the construction field at a predetermined distance and speed. Linear axes are particularly suitable for this purpose. These can guide the application means over the construction field via a belt drive and servo motors. However, linear axes with a spindle drive or linear motor are also possible. The drive of the two axes can be synchronized via a connecting shaft or via a so-called electrical coupling of individual electrical drives on both axes.

The drives must be able to move the application means over the construction field with a uniform movement speed of 0.2-2 m/s.

The linear axes have coupling points onto which the application units, integrated in a so-called process unit, are placed. The coupling points are designed to allow quick changing of the process unit and to bring the process unit back into the appropriate position without further adjustment steps.

The coupling points can be designed using a combination of so-called zero point clamps.

The process unit has application units for the particulate material and one or more fluids. In addition, it has other layer treatment means such as radiation sources or fumigants and inspection units such as line scan cameras.

The process unit is preferably symmetrical and has one or more print heads centrally. It preferably has 1 to 2 print heads. One print head is designed to span the entire long side of the construction field and to print a fluid on the entire long side in a suitable manner in one pass. The print heads are what is called drop-on-demand printing units with a large number of individually controllable nozzles. The resolution of a print head is usually 90-2000 dpi, advantageously 150 to 1200 dpi.

The print head(s) has (have) one or more fluid lines. They also have electrical contacts for transmitting the data and the control voltage, as well as lines for generating positive or negative pressure at the nozzles. All supply and discharge lines on the print head(s) are preferably designed to be coupled directly to or near the print head.

The print head(s) has (have) a holder that allows the position of the print head to the construction field and the height of the print head(s) above the construction field to be adjusted and fixed in a suitable manner.

In addition, the print head(s) is (are) mounted on a so-called offset axis, which allows the print head to move transversely in the direction of the long side of the construction field. The axis is designed in such a way that it can displace the print head by at least one nozzle width, preferably by 50 to 200 nozzle widths.

The displacement of the print head is activated in a suitable manner before each print run in order to avoid the overlapping of individual nozzles over the layer structure. This can be used to compensate for failed nozzles.

Spindle drives with servo motors are particularly suitable as offset axes. However, linear motors are also suitable.

On either side of the print head(s), there are application means or recoaters for applying layers of the particulate material.

The particulate material is preferably fed to the printer from above. The particulate material may be stored in a silo or otherwise continuously supplied, with the particulate material supply located substantially outside the machine. From there, the particulate material is transported to the printer by conveyor technology. Screw conveyors or screws or positive or negative pressure-based systems are particularly suitable for this task. The material is then temporarily stored in a feed container. The feed container also serves to distribute the material over the entire recoater width. Ultimately, the feed containers is an elongated silo whose length essentially corresponds to the recoater width. The width of the feed container is usually matched to the width of the recoater hopper. At least in the lower outlet area, the width of the feed container should be smaller than that of the recoater hopper. The height of the feed container must be designed so that sufficient particulate material is available for more than one coating pass, even in the edge region. Even more advantageously, enough particulate material should be available to completely fill the recoater hopper. The distribution of the particulate material in the feed container can be done via the material cone, but this requires greater heights of the container. Or the particulate material is distributed along the length of the container by a distribution device, such as a spiral or screw, located in the upper part of the container. There is a closable outlet opening in the lower part of the feed container. This opening is designed to extend into the recoater hopper and convey the particulate material there. Preferably, a closure mechanism on the feed container is designed to allow the recoater hopper to be filled to the same level at all times, regardless of the filling state of the recoater hopper prior to refilling. Different concepts can be considered for this purpose. A possible solution is a sliding mechanism with a sequence of openings and webs and a stationary counterpart shaped in the same way. If the moving part is moved relative to the stationary part so that the openings overlap, particulate material flows out. If, on the other hand, the mechanism is moved so that the openings overlap with the webs in each case, no particulate material can flow out.

Another embodiment of a suitable closure includes a flap extending along the length of the feed container and suspended on each of the narrow sides by a respective pivot point. A suitable form of a flap is, for example, a tube section, where the pivot points advantageously coincide with the center of the tube cross-section. Such a flap can be easily operated, for example, by means of a lever and a pneumatic cylinder. If the feed container is positioned above the hopper and the flap is opened, particulate material flows from the feed container into the hopper until a material cone forms at the transition from the feed container to the hopper and the particulate material flow is stopped. If the sand flap is then actuated, it separates the material cone and closes the feed container. The hopper is then filled evenly over the entire width.

The particulate material in the hopper is fed to the recoater during the coating pass. This is done either passively by simple draining or actively, e.g. by a rotary feeder at the lower end of the hopper. There are various embodiments for the recoater. One possible embodiment comprises a roller which extends in an oblong manner transversely to the coating direction and is operated in the opposite direction to the coating direction. A more advantageous embodiment includes a slit coater, which in turn is made up of an elongated container that can receive particulate material. The container is suspended in such a way that it can perform an oscillating movement about the longitudinal axis and is caused to oscillate by a drive. In the lower part of the container there is a slit-shaped outlet opening for the particulate material, which extends in the direction of the longitudinal axis. The opening may be directed either downward onto the construction field or laterally to the construction field. Particulate material then flows onto the construction field during oscillation operation.

In addition to the closing mechanisms of the feed containers, there are advantageous devices for extracting any dust that may be formed as a result of the filling movement of the particulate material into the hoppers. Such a device may consist of a slotted tube to which negative pressure is applied, e.g., via a suction device. The negative pressure is used to extract suspended or slowly sinking particles in the construction space atmosphere. Such a tube is preferably guided along the width of each of the two feed containers.

Preferably, the recoater whose hopper is being filled is located above a discharge hopper. The discharge hopper is a container which is located below the construction plane, to the side of the construction field, and has an opening in the construction plane that is at least as wide as the construction field, but preferably slightly wider. The discharge hopper receives excess particulate material that is, for example, in front of the recoater after a coating pass. Particulate material that escapes from the two containers during filling of the recoater or the hopper or is possibly scraped off after filling also ends up in the discharge hopper.

In the device according to the disclosure, two discharge hoppers can be arranged on both longitudinal sides of the construction field. Such a discharge hopper may have a funnel-like shape that facilitates discharge. Thus, at the lowest point of the hopper, the particulate material can be gathered in such a way that it can be easily transported away via a pneumatic conveyor or a feed screw or a screw conveyor.

In addition to the two openings for the discharge hoppers, there are two more openings on the left and right in the construction plane. These additional openings are designed in such a way that they can accommodate a cleaning station for the recoaters on the one hand and a cleaning station for the print head on the other. Since particulate material can escape from the recoater during cleaning and this could negatively influence the cleaning process of the print head, it makes sense to separate the two functions spatially as well. This also makes it easier to use different cleaning media. For example, the recoaters can be cleaned dry via directed compressed air or brushes that are guided along or across the recoater. Other cleaning mechanisms are also conceivable, such as a wiping unit with a moist carrier medium or a scraper blade. In all cases, the cleaning device can be passive or active. Passive means that a relative movement between the cleaning medium and the recoater takes place by active travel of the recoater. Active means that the recoater is stationary and the cleaning device moves relative to the recoater. Combinations of passive and active cleaning or different cleaning mechanisms are also conceivable.

The print head, on the other hand, can be cleaned via a liquid cleaning medium that is guided along the metering side of the print head, for example, via a brush, a wiping lip, an absorbent wiping lip, a sponge roller. In both cleaning cases, it makes sense to place the cleaning devices on the outside so that the devices can be kept easily accessible to the operator. Access is necessary to check the functioning of the cleaning devices or to perform regular maintenance and cleaning.

The print head itself consists of a plurality of printing modules that have a limited number of nozzles. Such printing modules usually eject individual droplets of a liquid binder from their nozzles with the aid of piezo actuators after the appropriate electrical signal is applied. The nozzles usually have diameters of 10-100 μm. The printing modules are inserted either individually or in smaller groups into a so-called print head carrier. It is important to ensure that the printing modules in the print head carrier are aligned with each other in such a way that the nozzles of all modules are, if possible, the same distance apart transverse to the direction of printing. In the embodiment according to the invention, the print head carrier extends along the entire length of the construction field and a small distance beyond. This distance is used to be able to displace the print head by a certain amount after each pass transverse to the direction of printing. The displacement is used to prevent faulty nozzles from overlapping in the printing of multiple layers.

The print head carrier has suitable receptacles for the printing modules and is designed to support the weight of the modules and at least its own weight in such a way that the sag of the print head over its length is only a few tenths of a millimeter. Usually, the distance of the print head to the construction field is 1-8 mm, more preferably 2-5 mm. To ensure that the print image to be generated on the construction field corresponds as closely as possible to the data model, this distance must be equal at every position on the construction field, if possible.

Above the print head carrier with the printing modules is a tank system for supplying the printing modules with liquid binding agent. There are also circuit boards for supplying the printing modules with the necessary electrical signals.

In the preferred embodiment, the print head carrier is designed to support all attachments and has means for positioning and fixing in the machine at both end faces. The machine itself again has the appropriate counterparts and also a device for moving the print head transversely to the direction of printing. This device consists, for example, of a threaded spindle drive on one side of the print head mount and a sliding bearing on the opposite side. The threaded spindle drive is operated via a servo motor with a flange-mounted speed sensor.

For positionally accurate generation of the print head signals, the machine has a linear scale which is located, for example, parallel to one of the two guide systems for the movement of the process unit. The probe of this linear scale is mounted on one of the coupling points on the linear axes and emits its signals when the process unit moves. The modules of the print head are controlled in response to these signals. This ensures that the desired print image is correctly deposited across the construction field regardless of the movement speed of the process unit.

The machine or arrangement has a construction container, preferably an exchangeable job box with a construction platform located therein. A job box is essentially a frame designed to prevent particulate material from flowing off the construction platform. Accordingly, the construction platform has a circumferential seal to the job box wall. The job box, including the construction platform, must be designed to support the weight of the particulate material after an entire job. Depending on the construction volume and material, this can be several hundred kilograms. Another requirement is that no, or at least very little, particulate material flows down between the job box wall and the construction platform even if the construction platform moves down during the construction job.

According to a preferred embodiment, the machine according to the invention has a changeover job box system to reduce the setup time between construction jobs. This means that job boxes of the same type can be moved in and out of the machine alternately. To ensure that this takes place without operator interaction, the job boxes are transported into the machine by means of a so-called infeed system from a conveyor located in front of the machine. A suitable infeed system, which incidentally also allows the job box to be moved out, is e.g. a chain conveyor system in the machine which preferably engages on both sides of the job box and pulls the box in and out of the machine on rails via laterally mounted guide rollers. It is obvious that other principles such as pneumatic cylinders, driven rollers and the like are also suitable for achieving this object. The conveyor system arranged in front of the machine and receiving the job box outside can, for example, have a driven roller conveyor on which the job box stands and which allows this box to be moved safely in and out of the machine.

This conveyor system can be statically mounted in front of the machine but can also be a self-propelled transport system. The main advantage of the latter is that the space in front of the machine is blocked only during the unloading cycles.

The following paragraph briefly describes the operation of the arrangement according to the invention.

In principle, the type of machine described is suitable for all materials that can be processed with the binder jetting process. These are, for example, molding sands, plastic materials, ceramic powders and metals. Furthermore, the machine can also be designed in such a way that so-called high-speed sintering can be carried out with it. In this case, the arrangement has suitable construction field heating and other equipment for sintering the particulate material.

The arrangement can be operated with different binder systems. These can be two-component or one-component binder systems. Without limiting the generality hereof, suitable binders include furan resins, phenolic resins, acrylic resins, epoxides, and inorganic binders such as water glass. However, other binders in solid form can also be mixed into the powder and activated by means of a liquid. This includes, for example, hydraulically setting binders such as cements that are printed with aqueous solutions. However, other substances such as starch, sugar and the like can also cause binding in the particulate material. Other bonds are made possible by at least superficial dissolution of the particulate materials. Certain alcohols or other solvents, for example, are suitable for this purpose.

In the preferred case, the machine is operated with molding sand and binders typically used for casting, such as furan resin and water glass.

For this purpose, the machine is filled with the particulate material. The binder supply is filled with the appropriate binder and the cleaning systems are filled with the appropriate cleaner.

The process unit first moves to the recoater cleaning position, where both recoaters are cleaned automatically. Then the process unit moves to the print head cleaning position, where a cleaning cycle for the print head is performed. This can include several so-called purges or rinsing processes, wiping processes with cleaning liquid and so-called spitting. Purging is the process of pressurizing the print head binder reservoir so that binder escapes to the nozzles. Spitting is understood to mean that all nozzles of the print head are controlled jointly for a specific number of droplet generations.

An empty job box is then fed into the machine by being drawn into the machine. The Z-axis automatically couples the construction platform with the coupling provided for this purpose and pushes the construction platform to the top position. The process unit then moves to a filling position. There, the feed container fills the respective hopper.

The process unit is then moved across the construction field, discharging particulate material, until it comes to a stop again in the opposite filling position. Here, the other hopper is filled by the corresponding feed container and the coating process is repeated. In this way, the so-called starting layer is created by passing over the construction field several times without printing. Said layer can consist of several layers and solves different aspects. On the one hand, a construction plane is created that is independent of the position of the construction platform. On the other hand, the machine and the construction field are brought up to process temperature. Once this process is complete, the actual printing process can begin. This requires the data to be printed in the form of individual bitmaps for the layers to be printed. Usually, the 3D data of the parts is broken down into individual layers and converted into bitmaps before the print job is recorded on a preparation computer.

Then the process unit moves from one filling position to another, depositing completely processed layers. This means that the construction platform is lowered by one layer thickness at a time, then the process unit prints the previous layer with binder, then applies a new layer of particulate material and treats the layer, e.g. with IR radiation.

During layering, the application units such as recoater and print head are cleaned at regular intervals.

After completion of the final layer, the construction platform can be lowered in the job box and the job box then transported out of the machine. Under certain circumstances, the completed print job is subjected to further subsequent processes such as thermal curing outside the machine.

Further embodiments of the disclosure will be described below.

In one aspect, the disclosure relates to an arrangement for layer-by-layer formation of moldings from a particulate material, comprising at least one process unit which can be guided to and installed in the arrangement, said process unit comprising a printing unit and a coating system, and an adjustment device for offline preparation of the process unit.

In another aspect, the disclosure relates to an arrangement for layer-by-layer formation of moldings from a particulate material, comprising

at least one process unit which can be guided to and installed in the arrangement, said process unit comprising a printing unit and a coating system, and a digital camera, a line camera or an IR camera, movable together with the process unit, for measurement of the construction field temperature or/and of the print image.

An arrangement according to the disclosure may preferably be characterized in that it comprises a receptacle for a construction container, which receptacle comprises a preferably automatic feeder for the construction container.

An arrangement according to the disclosure may preferably be characterized in that the coating system comprises a dynamic filling system.

An arrangement according to the disclosure may preferably be characterized in that the arrangement comprises an air conditioner, preferably wherein a control and/or process unit is/are connected to the air conditioner.

An arrangement according to the disclosure may preferably be characterized in that a line sensor is provided in an area between the recoater unit and the printing unit.

An arrangement according to the disclosure may preferably be characterized in that the line sensor is connected to a further process and/or control unit.

An arrangement according to the disclosure may preferably be characterized in that the arrangement comprises a bidirectional recoater or two recoaters, one respective recoater being provided for each coating direction.

An arrangement according to the disclosure may preferably be characterized in that a print head is arranged between two recoaters or a print head is arranged or attached in each case on both sides of a bidirectional recoater.

An arrangement according to the disclosure may preferably be characterized in that a digital camera, a line scan camera or an IR camera is arranged, in each case, laterally of the recoater and print head unit.

An arrangement according to the disclosure may preferably be characterized in that a digital camera, a line scan camera, or an IR camera is mounted in each of the forward and reverse directions of travel.

### DETAILED DESCRIPTION OF THE DRAWINGS

The invention will be described below with reference to preferred exemplary embodiments shown in the Figures.

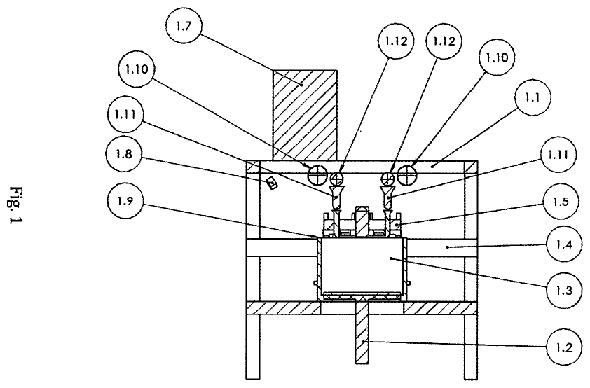

An example of an overall machine or overall system according to the disclosure is described, for example, in FIG. 1.

Essential components of the 3D printing system underlying the disclosure are:

The machine frame (1.1)

the Z axis (1.2)

the construction container (1.3)

the traversing axis (1.4)

the process unit (1.5)

the casing (1.6)

the air conditioners (1.7)

the suction device (1.10)

Some exemplary components and the interaction of the components according to the disclosure will be described in more detail below with reference to FIGS. 1-8.

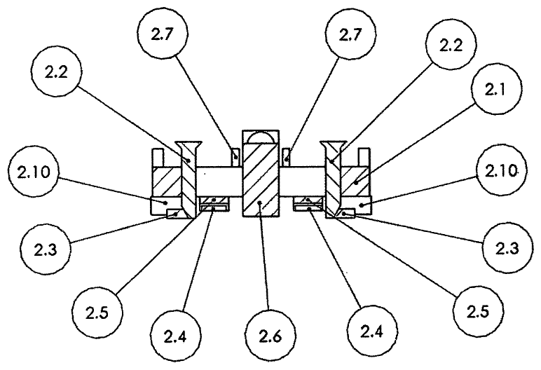

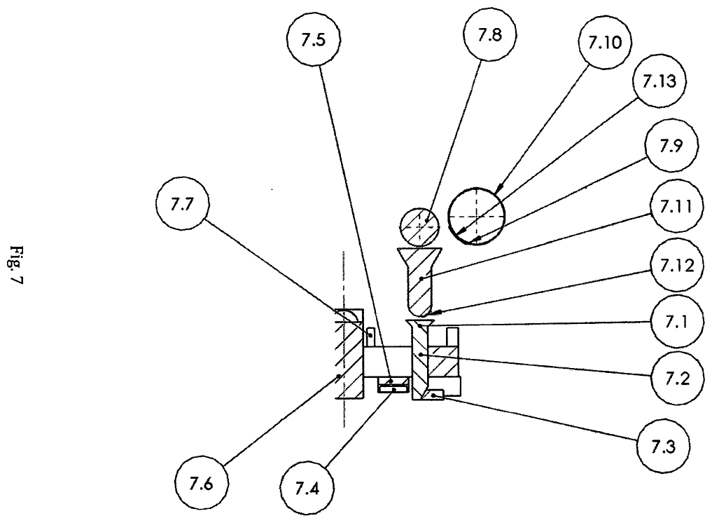

Examples of process units, adjustment devices, a recoater and a feed container according to the disclosure are shown in FIGS. 2 and 7.

For fully automatic construction operation, it is advantageous to equip the process unit (see FIG. 2) with recoaters (2.2, 7.7) that allow construction operation for several layers.

In order to allow the recoaters (2.7, 7.7) to be filled, they are equipped with suitable feed containers (7.11), suitable meaning in the present case that during filling via the feed containers (7.11), as a result of the distance actually present and the material cone forming, a hopper is arranged which can take up the excess particulate material running out of the feed container. In the present case, the particulate material (7.8) is fed via horizontally aligned chain conveyor systems. Since dust is typically also generated during filling, the system was equipped, directly at the filling point, with a preferably horizontal tube machine, which serves as a suction device (7.10). For this purpose, the tubes were provided with openings (7.9), such as holes or slots, laterally at the appropriate point. Suitable closure systems (7.13) can be used to trim the suction flow accordingly.

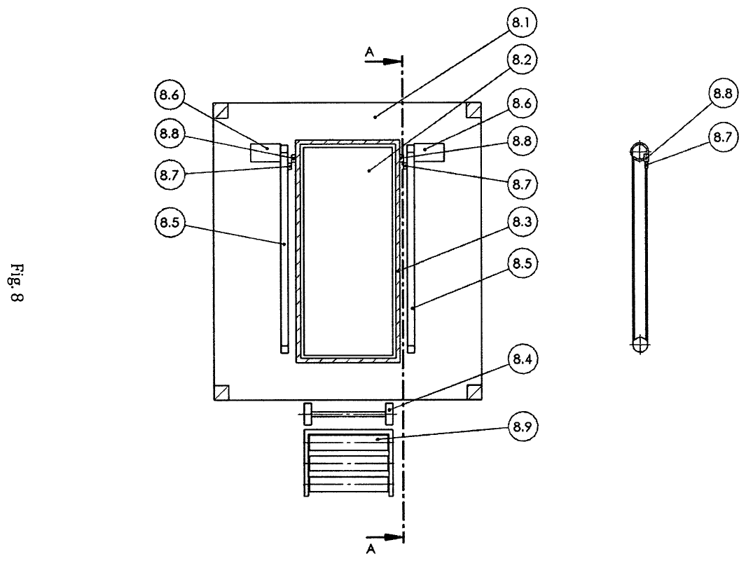

An exemplary job box feeder (construction container feeder) according to the disclosure is shown in FIG. 8.

In order to achieve the high degree of automation already described several times, a job box feeder had to be designed that can interact with the system linkage (roller conveyor segment, 8.9). For this purpose, the printing system was equipped with pulling means (8.5), which pull the construction container into the machine via the carriers (8.7, 8.8). By changing the direction of rotation of the drives (8.6), the carriers on the pulling means come to rest on the other side of the respective construction container carrier and can thus convey the box in the respective other direction. In order for the box to experience a better transition from the system linkage, i.e. roller conveyor (8.9) to the 3D printing system, the machine was equipped with support rollers (8.4). Preferably, these support rollers are free-running so that they can easily adapt to the speed of the pulling means as well as to the speed of the roller conveyor (8.9).

An exemplary IR camera according to the disclosure is shown in FIG. 1.

Since thermal management is an important contributor to parts quality in the present process, the present system was equipped with an IR camera system (1.8) that allows continuous monitoring of the construction field temperature (1.9).

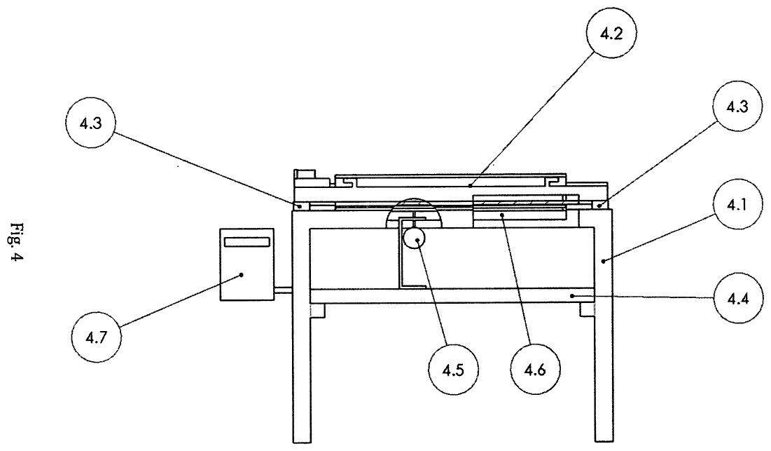

FIG. 4 describes an exemplary embodiment of an adjustment device according to the disclosure for offline preparation of the process unit.

In order to minimize machine downtimes during production, it is therefore recommended that the process unit be adjusted offline in a specially developed device. For this purpose, a device with integrated measuring equipment was developed which allows the process unit with its quick-release closure (4.3) to be set up, measured and, if necessary, readjusted in an installation situation simulating the machine (FIG. 1). For this purpose, the device was equipped with suitable guide elements (4.4), preferably with a flatness of +/−0.02 mm over the entire travel range, preferably approx. 1 m×1.5 m, in order to move the measuring head (4.5) in the directions of X and Y along the process unit. In order to be able to approach the measuring positions reproducibly, the guide elements (4.4) have integrated displacement measuring systems which can be visualized on the control panel (4.7). Preferably, a measuring head (4.5) with an electronic signal output is used so that the measured data can be visualized on the control panel on the one hand and automatically entered in a log on the other hand. Furthermore, the device has a parking position which has a print head closure (4.6) preventing the print head (2.6, 3.6) from drying out.

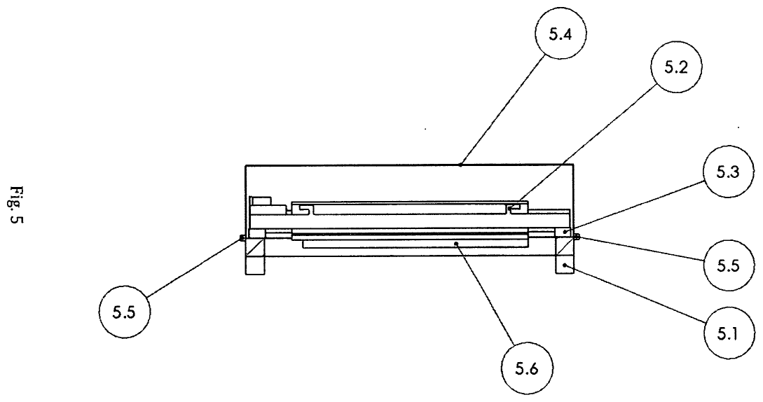

FIG. 5 shows an exemplary transport box with permanent print head moisturizing according to the disclosure.

Since the process unit (5.2) is a highly sensitive and also cost-intensive assembly, a device was developed which makes it possible to store the process unit (5.2) with fully equipped print head in prepared form for immediate use for the 3D printer, i.e. filled with the print medium, ready for operation, for several days. Transport box consisting of a base frame (5.1) with print head closure (5.6) and shockproof cover (5.4). For clear positioning of the process unit (5.2), the quick-release closures (5.3) are used as in the 3D printer.

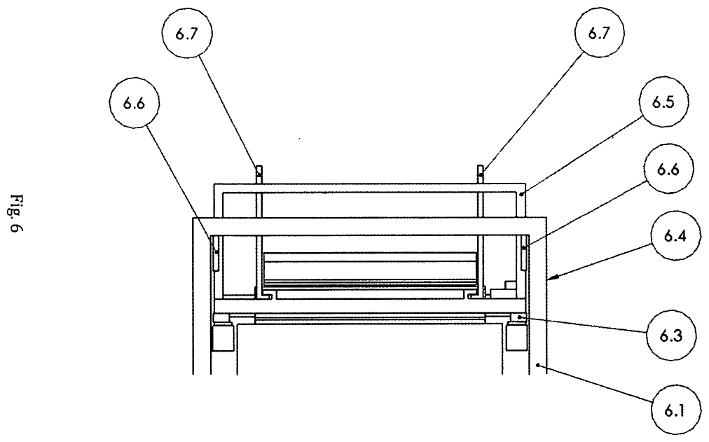

FIG. 6 illustrates an exemplary embodiment of a removal aid for damage-free removal/installation of the process unit according to the disclosure.

Since the present 3D printing system is designed for high process automation and, consequently, several of these systems will act in combination with fully automated interlinking, it may be useful for the process units to be transported to and away from the machines and lifted into and out of the machines by a universal lifting device (6.5). To ensure that the highly sensitive process unit (6.2) is not damaged in the process, a device was developed to ensure guided removal (6.6) from the machine and all-round protection after removal. In the present case, a purely mechanical solution (6.7) was chosen, but a fully automatic solution that can interact with the respective machine control system would also be conceivable.

FIGS. 1-3 further describe an exemplary process unit according to the disclosure.

To meet the requirements for high availability and, consequently, reduced maintenance time, the present 3D printing system was developed with a quick-change machine for the print head (2.6, 3.6), horizontal offset (3.8), recoater (2.2, 3.2), IR radiator (2.4, 3.4) and other relevant components. For this purpose, the relevant components were combined in a highly integrated and self-supporting process unit. Equipped with a quick clamping system (3.10) for mounting the process unit on the traversing axis (1.4) and quick-release closures for all media (power, air, binder, etc.), a compact unit was created that can be installed in or removed from the 3D printing system in the shortest possible time according to requirements. Another advantage of the present solution is its multiple usability, since, as explained elsewhere, a 3D printing system network is to be set up, and the process unit can be used in any 3D printing system belonging to the network. This is also made possible by the offline adjustment of the process unit in the adjustment device described below (see also FIG. 4). The process unit substantially consists of the frontal mounting plates (3.1) with the quick clamping system (3.10) attached to them and the combination of: full-width and inherently rigid print head (2.6 and 3.6) with horizontal offset (3.8), recoater unit (2.2, 3.2) and IR radiator (2.4, 3.4) with water cooling (2.5, 3.5). The inherently rigid print head configuration also enables the print head (2.6, 3.6) to be changed quickly. The system is supplemented by the line scan camera (2.7, 3.7) for in situ print image acquisition and the recoater closure (2.3, 3.3), in this case designed as a vacuum closure (2.3, 3.3), in order to ensure the longest possible service life with minimum wear in the large number of cycles.

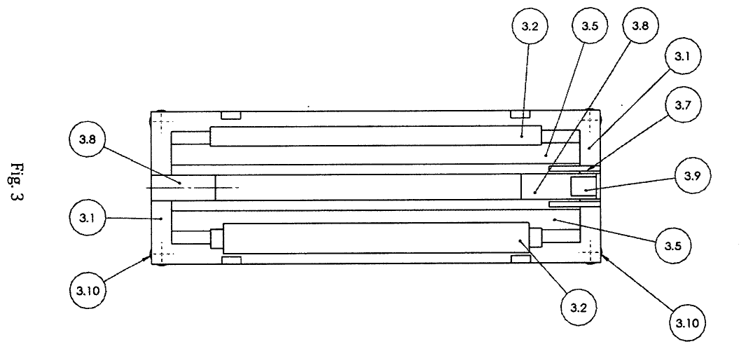

An exemplary inspection means in the form of a line scan camera according to the disclosure is shown in FIG. 2 and FIG. 3.

A major disadvantage of the systems available on the market is that the print result is only visible at the end of the complete printing operation, i.e. when the construction container is unpacked. Since this can sometimes take several hours, a lot of precious time is lost. Known systems already use common camera systems to inspect the print image after finishing the respective layer (e.g. VUT, REVIEW OF AN ACTIVE RE-COATER MONITORING SYSTEM FOR POWDER BED FUSION SYSTEMS).

Due to the bidirectional mode of operation, this technique cannot be used in the present machine and an adapted system had to be developed that can be mounted between the print head and the recoater, thus enabling in situ inspection of the print image even in the bidirectional mode of operation. For this purpose, a line scan camera (2.7, 3.7) was integrated, in each case, between the print head (2.6, 3.6), the right and left recoater (2.2, 2.3) and then equipped with specially adapted software, which can then compare the real print image with the target image and thus show the operator any faults in the process at an early stage. The operator can then decide whether to abort printing or let it continue to the end.

### LIST OF REFERENCE NUMERALS

FIG. 1
1.1 machine frame (1)
1.2 Z axis (2)
1.3 construction container/job box (3)
1.4 traversing axis (4)
1.5 process unit (5)
1.6 casing (6)
1.7 air conditioner(s) (7)
1.8 IR camera (infrared camera) (8)
1.9 construction field (9)
1.10 suction device (10)
1.11 feed container (11)
FIG. 2
2.1 mounting plate (1)
2.2 recoater unit (2)
2.3 vacuum closure (3)
2.4 IR radiator (infrared radiator) (4)
2.5 water cooling IR (water cooling infrared) (5)
2.6 print head (6)
2.7 line scan camera (7)
FIG. 3
3.1 mounting plate (1)
3.2 recoater unit (2)
3.3 vacuum closure (3)
3.4 IR radiator (4)
3.5 water cooling IR (5)
3.6 print head (6)
3.7 line scan camera (7)
3.8 horizontal offset (8)
3.9 drive for horizontal offset (9)
3.10 quick clamping system (10)
4.1 base frame (1)
4.2 process unit (2)
4.3 quick-release closure (3)
4.4 X-Y guide system (4)
4.5 measuring device (gauge) (5)
4.6 print head closure (6)
4.7 control panel with display of measurement data (7)
FIG. 5
5.1 base frame (1)
5.2 process unit (2)
5.3 quick-release closure (3)
5.4 cover (4)
5.5 lock (5)
5.6 print head closure (6)
FIG. 6
6.1 base frame (1)
6.2 process unit (2)
6.3 quick-release closure (3)
6.4 cover (4)
6.5 removal aid (5)
6.6 guide element (6)
6.7 transport lock (7)
FIG. 7
7.1 recoater hopper (1)
7.2 recoater (2)
7.3 vacuum closure (3)
7.4 IR radiator (4)
7.5 water cooling IR (5)
7.6 print head (6)
7.7 line scan camera (7)
7.8 particulate material feed (8)
7.9 suction opening (9)
7.10 suction device (10)
7.11 feed container (11)
7.12 feed container fastener (12)
7.13 suction device closure (13)
FIG. 8
8.1 machine frame (1)
8.2 Z axis (2)
8.3 construction container (3)
8.4 support rollers (4)
8.5 pulling means (5)
8.6 feeder drive (6)
8.7 pulling means carrier (7)
8.8 construction container carrier (8)
8.9 roller conveyor segment (9)

What is claimed is:

1. An arrangement for layer-by-layer formation of moldings from a particulate material, comprising at least one process unit which can be guided to and installed in the arrangement, said process unit comprising a printing unit and a coating system, and an adjustment device for offline preparation of the process unit.

2. An arrangement for layer-by-layer formation of moldings from a particulate material, comprising at least one process unit which can be guided to and installed in the arrangement, said process unit comprising a printing unit and a coating system, and a digital camera, a line camera or an IR camera, movable together with the process unit, for measurement of the construction field temperature or/and of the print image.

3. The arrangement according to claim 1 comprising a receptacle for a construction container, which receptacle comprises a preferably automatic feeder for the construction container.

4. The arrangement according to claim 1, wherein the coating system comprises a dynamic filling system.

5. The arrangement according to claim 1, wherein the arrangement comprises an air conditioner, preferably wherein a control and process unit is connected to the air conditioner.

6. The arrangement according to claim 1, wherein a line sensor is provided in an area between the recoater unit and the printing unit.

7. The arrangement according to claim 6, wherein the line sensor is connected to a further process and control unit.

8. The arrangement of claim 1, wherein the arrangement comprises a bidirectional recoater or two recoaters, one respective recoater being provided for each coating direction.

9. The arrangement of claim 1, wherein a print head is arranged between two recoaters or a print head is attached in each case on both sides of a bidirectional recoater.

10. The arrangement of claim 1, wherein a digital camera, a line scan camera or an IR camera is arranged, in each case, laterally of the recoater and print head unit.

11. The arrangement according to claim 10, wherein a digital camera, a line scan camera, or an IR camera is mounted in each of the forward and reverse directions of travel.

12. The arrangement of claim 2, comprising a receptacle for a construction container, which receptacle comprises a preferably automatic feeder for the construction container.

13. The arrangement of claim 2, wherein the coating system comprises a dynamic filling system.

14. The arrangement of claim 2, wherein the arrangement comprises an air conditioner, preferably wherein a control and process unit is connected to the air conditioner.

15. The arrangement of claim 2, wherein a line sensor is provided in an area between the recoater unit and the printing unit.

16. The arrangement according to claim 15, wherein the line sensor is connected to a further process and control unit.

17. The arrangement of claim 2, wherein the arrangement comprises a bidirectional recoater or two recoaters, one respective recoater being provided for each coating direction.

18. The arrangement of claim 2, wherein a print head is arranged between two recoaters or a print head is attached in each case on both sides of a bidirectional recoater.

19. The arrangement of claim 1, wherein a digital camera, a line scan camera or an IR camera is arranged, in each case, laterally of the recoater and print head unit.

20. The arrangement of claim 19, wherein a digital camera, a line scan camera, or an IR camera is mounted in each of the forward and reverse directions of travel.
